(19) United States
(12) Patent Application Publication
(10) Pub. No.: US 2014/0255579 A1
(43) Pub. Date: Sep. 11, 2014

(54) Stevia rock crystal article

(71) Applicants: Solomon J. Nachfolger, Monsey, NY (US); Cecilia Cabieses, Plantation, FL (US)

(72) Inventors: Solomon J. Nachfolger, Monsey, NY (US); Cecilia Cabieses, Plantation, FL (US)

(21) Appl. No.: 13/815,579

(22) Filed: Mar. 11, 2013

(51) Int. Cl. A23L 1/236

(52) U.S. Cl. CPC A23L 1/2363
USPC 426/548

(57) ABSTRACT

A rock crystal article comprising a mixture of stevia and erythritol disposed on the surface of a crystal nucleation agent. The crystal nucleation agent comprises a stirrer for convenient dispensing of the mixture into a liquid such as coffee or tea. The stirrer will have a handle region not containing any of the mixture and a dispensing region containing the mixture. Typically, the stirrer will be fabricated from wood or a polymer such as polypropylene. The stevia will be present in an amount of about 20 to about 80 wt. %, based on the weight of the mixture.

### FIELD OF THE INVENTION

The invention pertains to a rock crystal article comprising a mixture of stevia and erythritol disposed on the surface of a crystal nucleation agent.

### BACKGROUND OF THE INVENTION

Stevia is a genus of about 240 species of herbs and shrubs in the sunflower family. The species Stevia rebaudiana, commonly known as “sweetleaf”, “sweet leaf”, or simply “stevia”, is widely grown for its sweet leaves. The active ingredient of stevia is known and is commercially available as “Rebiana”. “Rebiana” is the trade name for high purity rebaudioside A, a steviol glycoside non-caloric, non-nutritive sweetener having a sweetness level of up to 300 times of that of sucrose. For the purposes of this invention, all of the aforementioned species and compositions are hereinafter collectively referred to as “stevia”.

Stevia is derived from stevia leaves by steeping them in water. Crystalline forms of stevia that are stable in the atmosphere are unknown prior to this invention since stevia is very hygroscopic. Typically, stevia will absorb 2-10% water within one hour, thus making it almost impossible to crystallize.

By analogy, rock candy is a confectionary composed of relatively large sucrose crystals. Rock candy is formed by allowing a super-saturated solution of sucrose and water to crystallize on a surface suitable for crystal nucleation such as a string or stick. Heating the water to approximately 80° C. before adding the sucrose allows more sucrose to dissolve, thus producing large crystals. The same technique cannot, however, be used to form crystals of stevia without a crystal promoter being present with the stevia.

### DETAILS OF THE INVENTION

It has now been found that the analogous process for producing rock candy from supersaturated solutions of sucrose may be used to form rock crystal stevia from a hot super-saturated water solution of stevia provided that the solution also contains erythritol which functions as a crystal promoter. Upon cooling, rock crystal stevia will form on a crystal nucleation surface such as a string or stick. If desired, food coloring may be added to the solution before cooling to thereby provide a colored rock crystal stevia.

The supersaturated solution may be formed by heating water to a temperature of 80-90° C. and adding, with stirring, a mixture of stevia and erythritol in the desired proportions to the hot water until no more mixture will dissolve in the water. Thereafter, a crystal nucleation agent such as a typical wooden coffee stirrer, is inserted in the hot supersaturated solution and the solution is allowed to cool. After a period of time ranging from about two hours to six days, the mixture will crystallize on the stirrer. Typically, the crystal nucleation agent, i.e. the stirrer, will be in the form of an elongated body containing a handle region not containing the rock crystal composition (since such region is not immersed in the supersaturated solution) and a dispensing region containing the rock crystal composition (the latter is the region immersed in the supersaturated solution).

In general, the time for crystallization upon the crystal nucleation agent will vary depending on the relative proportions of the stevia and erythritol in the supersaturated solution. Typically, the higher the percentage of erythritol in the mixture, the shorter the period of time required for crystallization upon the surface of the crystal nucleation agent. The amount of the crystals deposited on the surface of the crystal nucleation agent will depend on the period of time the crystal nucleation agent is in contact with the supersaturated solution. The content of the stevia in the crystals will, of course, be dependent upon the relative proportions of the stevia and the erythritol in the supersaturated solution.

Although the crystal nucleation agent is typically a wooden stick that is conventionally 5 to 8 inches in length, it may be comprised of a polymer such as polypropylene in the form and dimensions associated with coffee stirrers.

For best results, the relative proportions of stevia and erythritol in the mixture to be added to the hot water to form the supersaturated solution should be in the range of about 20 to about 80 wt. %, preferably 30 to 70 wt. %, of stevia, based on the weight of the mixture added to the hot water.

The following non-limiting examples shall serve to illustrate embodiments of this invention. Unless otherwise indicated, all parts and percentages are on a weight basis. It is to be understood that these examples shall not serve to limit the scope of the invention which is defined solely by the claims which follow.

In all of the examples, the term “purified” water is employed. The water which was employed in the examples was purified by pre-boiling followed by contact with Brita® carbon and thereafter filtered through a bed of ion-exchange resin.

### Example 1

35.7 g of Stevia Leaf extract (“Mood and Mind”, Davenport, Fla. standardized 90% steviasides, 5% moisture content) were added to 100 g of purified water that had been heated to 84-86° C. resulting in a light yellow, clear solution having a stevia content of 26.3 wt. %. The solution was subjected to accelerated evaporation by having air blowing over the surface of the solution. After 6 days, no crystallization was observed.

### Example 2

51.0 g of KAL Pure Stevia Extract (Nutraceutical Corp., Park City, Utah, 100% Stevia Rebaudiana leaf supplying steviosides were added to 100 g of purified water that had been heated to 84-86° C. resulting in a light yellow, clear solution having a stevia content of 33.8 wt. %. In this example, the stevia dissolved more quickly than that in Example 1. The solution was subjected to accelerated evaporation by having air blowing over the surface of the solution. Less than 10 g of the original 51 g crystallized after 6 days.

### Example 3

Example 1 was repeated using 41.0 g of 100% pure Stevia Leaf Extract (Steviva Brands, Portland, Oreg.). The resultant dark yellow solution contained 29.1 wt. % stevia with a solubility and odor similar to that of Example 1. The solution was subjected to accelerated evaporation by having air blowing over the surface of the solution. No crystallization was observed after 6 days.

### Example 4

Example 1 was repeated using 36.0 g of Radiant 100% Stevia Extract with 90% steviosides (Radiant Marketing LLC, Woodstock, Ga.). The resultant light yellow solution contained 26.5 wt. % stevia with a solubility and odor similar to that of Example 1. The solution was subjected to accelerated evaporation by having air blowing over the surface of the solution. No crystallization was observed after 6 days.

### Example 5

Example 1 was repeated using 268 g of Truvia®. Truvia® is described as a mixture of erythritol, <14% Rebiana and natural flavors. The resultant clear solution had a Rebiana Stevia content of <11 wt. %. The solution was subjected to accelerated evaporation by having air blowing over the surface of the solution. Crystallization started within two hours and proceeded rapidly. After six days, the crystals were removed from the solution and air-dried.

### Example 6

Example 1 was repeated using 100 g of “PureVia” and 80 g of purified water. “PureVia” is described as a mixture of dextrose, Reb A (stevia extract), cellulose powder and natural flavors (Whole Earth Sweetener Co. Chicago, Ill.). No crystallization had occurred after 6 days.

### Example 7

Example 1 was repeated using 40 g of “Sweet Leaf” mixture of “Inulin” soluble fiber and Sweet Leaf stevia (Wisdom Natural Brands, Gilbert, Ariz.). No crystallization had occurred after 6 days.

### Example 8

Example 1 was repeated using 70 g of “Sun Crystals” mixture of pure cane sugar and <23% stevia (McNeil Nutritionals LLC, Fort Washington, Pa.). No crystallization had occurred after 6 days.

### Example 9

Example 1 was repeated using 49.6 g of “Stevia Extract In The Raw” mixture of dextrose and stevia extract (Cumberland Packing Co., Brooklyn, N.Y.) and 117 g of water. No crystallization had occurred after 6 days.

The next series of experiments were carried to determine the relationship between the amount of erythritol and the stevia and the amount of rock crystals obtained after the indicated weights of erythritol and stevia were mixed with purified water in the manner set forth in Example 1 above.

The rock crystals were then recovered after three days, air dried and subsequently oven dried at 105° C. The table below sets forth the results of these experiments.

| Exp. No. | Erythritol, g | Stevia, g | Water, g | Recovered Crystals, g |
|---|---|---|---|---|
| 1 | 0 | 51 | 100 | <10 |
| 2 | 5 | 50 | 100 | 1 |
| 3 | 12.5 | 50 | 100 | 4 |
| 4 | 25 | 50 | 100 | 16 |
| 5 | 37.5 | 50 | 100 | 13.5 |
| 6 | 45 | 50 | 100 | 10 |
| 7 | 100 | 50 | 100 | 70 |

It should be noted that although the highest yield of rock crystals was obtained in Experiment No. 7 with the highest ratio of erythritol to stevia, such an erythritol rate is nevertheless undesirable since erythritol can cause digestive problems. Furthermore, the presence of large amounts of erythritol serves to dilute the sweetness of stevia. Erythritol is known to have a sweetness equivalent to about 60% of that of sucrose, while stevia has a sweetness of 300 times that of sucrose.

What is claimed is:

1. A rock crystal article comprising a mixture of stevia and erythritol disposed on the surface of a crystal nucleation agent.

2. The article of claim 1 wherein the crystal nucleation agent comprises a stirrer for convenient dispensing of the mixture into a liquid.

3. The article of claim 2 wherein the stirrer has an elongated body containing a handle region not containing the mixture and a dispensing region containing the mixture.

4. The article of claim 2 wherein the stirrer is comprised of wood.

5. The article of claim 3 wherein the stirrer is comprised of a polymer.

6. The article of claim 1 wherein the stevia is present in an amount of about 20 to about 80 wt. %, based on the weight of the mixture.

7. The article of claim 7 wherein the stevia is present in an amount of 30 to 70 wt. %, based on the weight of the mixture.

8. The article of claim 1 wherein the mixture further comprises a food colorant.
